(19) United States
(12) Patent Application Publication
(10) Pub. No.: US 2007/0198124 A1
(43) Pub. Date: Aug. 23, 2007

(54) Single control object providing display tool width and influence control

(75) Inventor: Hubert L. Lacey III, Dallas, TX (US)

Correspondence Address: LAW OFFICE OF DAVID H. JUDSON, 15950 DALLAS PARKWAY, SUITE 225, DALLAS, TX, 75248, US

(73) Assignee: D4D Technologies, LP

(21) Appl. No.: 11/359,078

(22) Filed: Feb. 22, 2006

(51) Int. Cl. G06F 19/00

(52) U.S. Cl. 700/180; 345/419

(57) ABSTRACT

An area-of-effect control is associated with a given graphical user interface tool and comprises a circle with a hemisphere superimposed on the circle's diameter. The control's geometry is changed by a user to vary an effect of the tool in the graphical user interface. Thus, for example, the user may change the diameter of the hemisphere, for example, to change an area that is paint-brushed by the tool; or, the user may vary the height or depth of the hemisphere to change the influence of the tool, such as the amount painted. The diameter and height may be varied at the same time. In addition, the hemisphere may be dragged in a negative manner, i.e., below an equator of the circle, to indicate that material may be subtracted from the virtual canvas. Thus, the equatorial circle of the control is used to provide a first (e.g., paintbrush) effect, and the hemisphere of the control is used to provide a second (e.g., a material addition or subtraction, or some other push/pull manipulation) effect. The control may change dynamically dependent upon the particular effect desired or tool chosen.

### BACKGROUND OF THE INVENTION

1. Technical Field

The present invention relates to computer-assisted techniques for creating dental restoration models.

2. Brief Description of the Related Art

The art of fabricating custom-fit prosthetics in the dental field is well-known. Prosthetics are replacements for tooth or bone structure. They include restorations, replacements, inlays, onlays, veneers, full and partial crowns, bridges, implants, posts, and the like. Typically, a dentist prepares a tooth for a restoration by removing existing anatomy, which is then lost. The resultant prepared area (a “preparation”) is then digitized (or, in the alternative, a dental impression is taken) for the purpose of constructing a restoration. The restoration itself may be constructed through a variety of techniques including manually constructing the restoration, using automated techniques based on computer algorithms, or a combination of manual and automated techniques.

Computer-assisted techniques have been developed to generate three-dimensional (“3D”) visual images of physical objects, such as a dental preparation. In general, the 3D image may be generated by a computer that processes data representing the surfaces and contours of a physical object. The computer displays the 3D image on a screen or a computer monitor. The computer typically includes a graphical user interface (GUI). Data is generated by optically scanning the physical object and detecting or capturing the light reflected off of the object. Based on processing techniques, the shape, surfaces and/or contours of the object may be modeled by the computer.

During the process of creating a tooth restoration model, one or more user interface tools may be provided to facilitate the design process. One such tool may be a simulated “dropper” that is used to add virtual droplets of material to the restoration model. The diameter of the tool's influence, as well as the tool's “strength,” however, must be tightly controlled. Typically, control over each of these characteristics (diameter and strength) is carried out with two (2) or more separate and distinct control elements, such as sliders, fill-in boxes, or the like. While such techniques can provide satisfactory results, there is a need to the art to provide improved and more precise controls. The present invention addresses this need.

### BRIEF SUMMARY OF THE INVENTION

It is an object of the present invention to provide a single graphical user interface (GUI) object that controls an area-of-effect that a particular tool is operating within, as well as the influence of such effect.

A more specific object of the invention is to provide a user interface control to manipulate the area-of-effect for one or more tools used in tooth restoration design.

In an illustrative embodiment, an area-of-effect control is associated with a given graphical user interface tool and comprises a circle with a hemisphere superimposed on the circle's diameter. The control's geometry is changed by a user to vary an effect of the tool in the graphical user interface. Thus, for example, the user may change the diameter of the circle, for example, to change an area that is paint-brushed by the tool; or, the user may vary the height of the hemisphere to change the influence of the tool, such as the amount painted (the intensity or strength). The diameter and height may be varied at the same time. In addition, the hemisphere may be dragged in a negative manner, i.e., below an equator of the circle, to indicate that material may be subtracted from the virtual canvas.

Thus, in a representative embodiment, the equatorial circle of the control is used to provide a first (e.g., paintbrush) effect, and the hemisphere of the control is used to provide a second (e.g., a material addition or subtraction, or some other push/pull manipulation) effect. The control may change dynamically dependent upon the particular effect desired or tool chosen.

According to another feature, numerical unit displays are provided adjacent each of the circle and the hemisphere, and the values within these displays are adjusted as the elements of the single control are manipulated.

Other features and advantages of the invention will be apparent to one with skill in the art upon examination of the following figures and detailed description. It is intended that all such additional features and advantages be included within this description, be within the scope of the invention, and be protected by the claims.

### BRIEF DESCRIPTION OF THE DRAWINGS

The invention may be better understood with reference to the following drawings and its accompanying description. Unless otherwise stated, the components in the figures are not necessarily to scale, emphasis instead being placed upon illustrating the principles of the invention. Moreover, in the figures, like referenced numerals designate corresponding parts throughout the different views.

FIG. 1 illustrates a computer system in which the inventive method may be implemented;

FIG. 2 depicts the single control object of the present invention in a default or rest position;

FIG. 3 depicts the control object in a first mode of operation, wherein an equatorial circle is provided in a single plane for varying an associated display tool's relative width;

FIG. 4 depicts the control object in a second, preferred mode of operation, which provides a two axis control for varying width and influence;

FIG. 5 illustrates a depicts the single control object in the second or two-axis mode, with the “effect” axis drawn to a negative value depicting the two axis of movement in the vertical and horizontal planes;

FIG. 6 illustrates the single control object in the two-axis mode, with the width and height being changed together; and

FIGS. 7A and 7B are illustrative process flow diagrams depicting how the control object is drawn on the graphical user interface.

### DETAILED DESCRIPTION

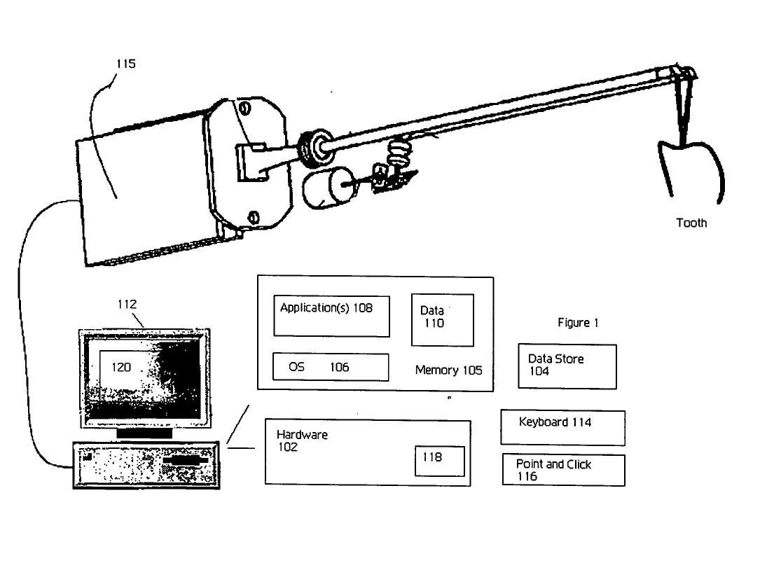

The present invention provides a display method, preferably implemented in a computer. For illustrated purposes, the computer is a single machine, but this is not a limitation. More generally, the method is implemented using one or more computing-related entities (systems, machines, processes, programs, libraries, functions, code, or the like) that facilitate or provide the inventive functionality. As seen in FIG. 1, a representative machine is a computer running commodity hardware, an operating system, an application runtime environment, and a set of applications or processes (e.g., linkable libraries, native code, or the like, depending on platform), that provide the functionality of a given system or subsystem. The invention may be implemented in a standalone machine, or across a distributed set of machines.

More specifically, the computer 100 comprises hardware 102, suitable storage 104 and memory 105 for storing an operating system 106, one or more software applications 108 and data 110, conventional input and output devices (a display 112, a keyboard 114, a point-and-click device 116, and the like), other devices 118 to provide network connectivity, and the like. A laser digitizer system 115 is used to obtain optical scans, e.g., from preexisting anatomy. A representative digitizer system is described in commonly-owned, co-pending published application No. 20040254476, the disclosure of which is incorporated herein by reference. Using a conventional graphical user interface 120, an operator can view and manipulate models as they are rendered on the display 112.

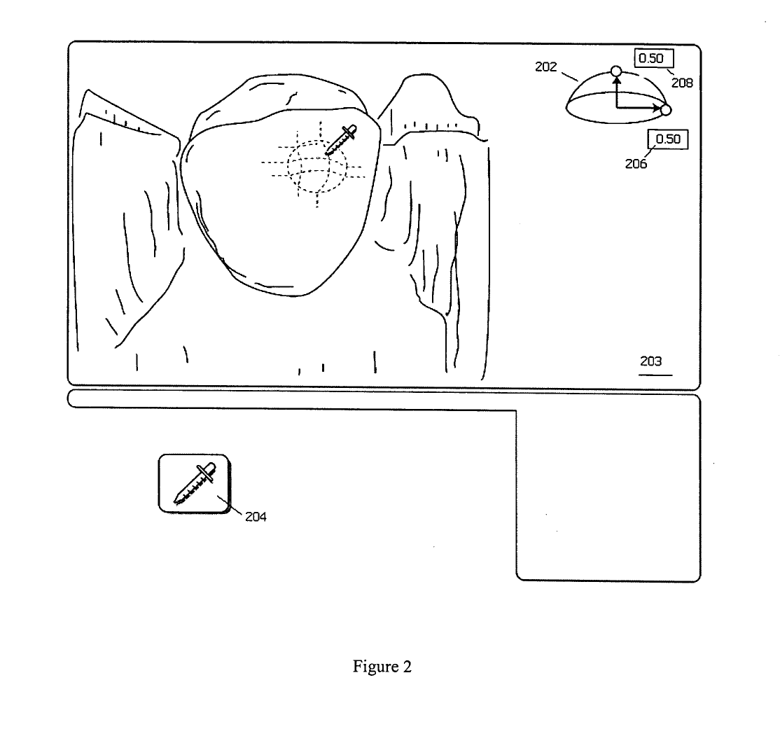

FIG. 2 illustrates a portion of a representative graphical user interface 200 showing the control object 202 in a default or rest position. The control object 202 is located on the primary design canvas 203, although this is not a requirement. The graphical user interface also comprises one or more design tools. The particular tools that are implemented are not an aspect of the present invention. It is assumed, however, that a particular GUI tool has at least first and second characteristics, such as area (e.g., size) and influence (e.g., strength, intensity, or the like). One such tool may be a simulated “dropper” 204 that is used to add or remove virtual droplets of material to or from a tooth restoration model being designed. In this representative case, the first and second characteristics comprise the width of the tool and its influence.

According to one embodiment of the invention, a single control comprises a display object that is generated in software (e.g., a set of computer program instructions) executable in at least one processor. A representative implementation is computer program product comprising a tangible medium on which given computer code is written, stored or otherwise embedded. The computer code provides a set of display functions that are now described.

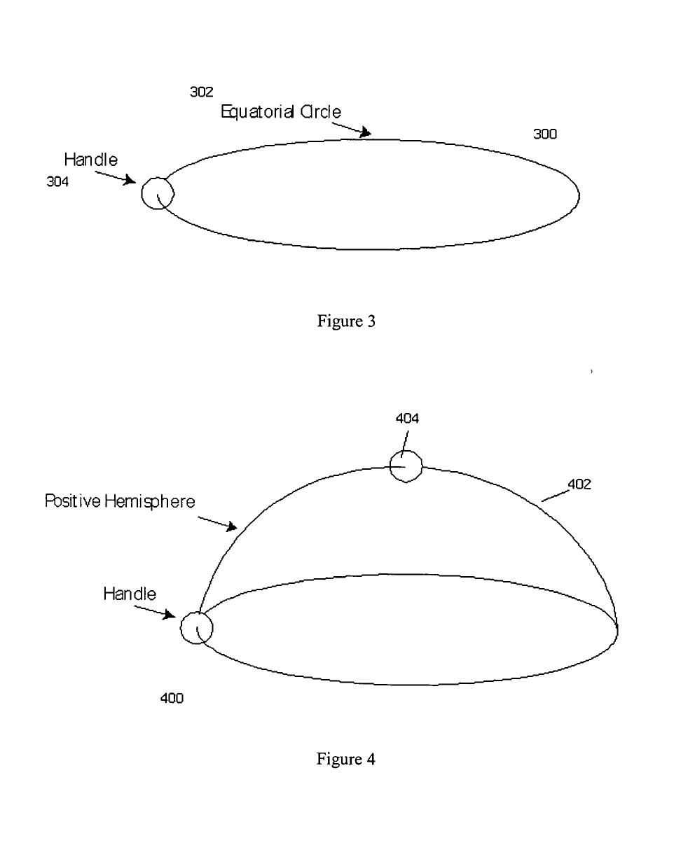

As seen in FIG. 3, the control object 300 comprises a closed curved planar FIG. 302 having an associated display element 302. The closed curved planar figure preferably is a circle having an outer edge, which is the diameter. The display element 302 is a handle that can be grabbed in any convenient manner, typically by moving a point-and-click device element (e.g., a mouse cursor) to the display element 302 and then selecting the element (e.g., by clicking the mouse). Once it is grabbed in this way, the handle is moved (left or right in the plane of the drawing) to enlarge or reduce the width of the circle. This action serves to set the effective width or size of the display tool.

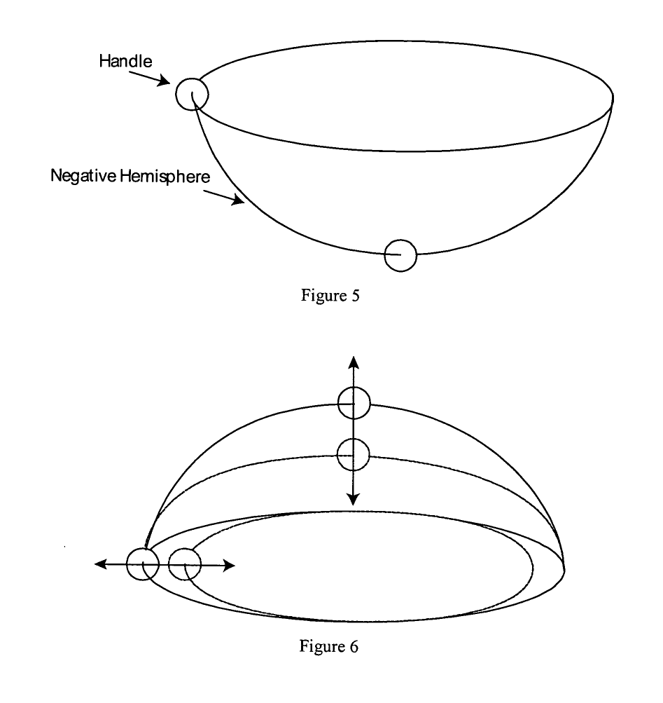

Preferably, the control object also includes a hemisphere 402 superimposed on the circle's diameter, as illustrated in FIG. 4. The hemisphere 402 preferably includes its own associated display handle 404. In the preferred embodiment, the circle and the hemisphere are displayed transparently, relative to each other, such that the display element associated with the hemisphere may be manipulated in a first, positive direction, such as seen in FIG. 4, or a second, negative direction, such as seen in FIG. 5. In this way, the hemisphere portion of the control object is used to modify or adjust the influence of the display tool, either in a positive manner or in a negative manner. Thus, for example, in the case of a design tool being a dropper, the hemisphere tool can be used to add material to a tooth restoration model being designed on a virtual canvas, or to remove material from the restoration model. The amount of such material being added or removed depends on the “width” of the circle, as has been described.

Thus, as seen in FIG. 6, the present invention is a single control object comprising a circle with a hemisphere superimposed on the circle's diameter, wherein the circle and the hemisphere are displayed transparently, relative to each other, such that the display element associated with the hemisphere may be manipulated in a first, positive direction, or a second, negative direction. By grabbing and manipulating the handles, the user can modify at least one of a width of the circle, or a positive or negative height of the hemisphere relative to the circle. Thus, using only a single object, such actions control both the display tool's size and influence.

As also seen in FIG. 2, as the handles are manipulated, the values in numerical unit displays 206 and 208 are modified accordingly. If desired, these fields may be filled-in with given values, which action causes the circle and hemisphere (and the associated display tool) to be re-sized accordingly.

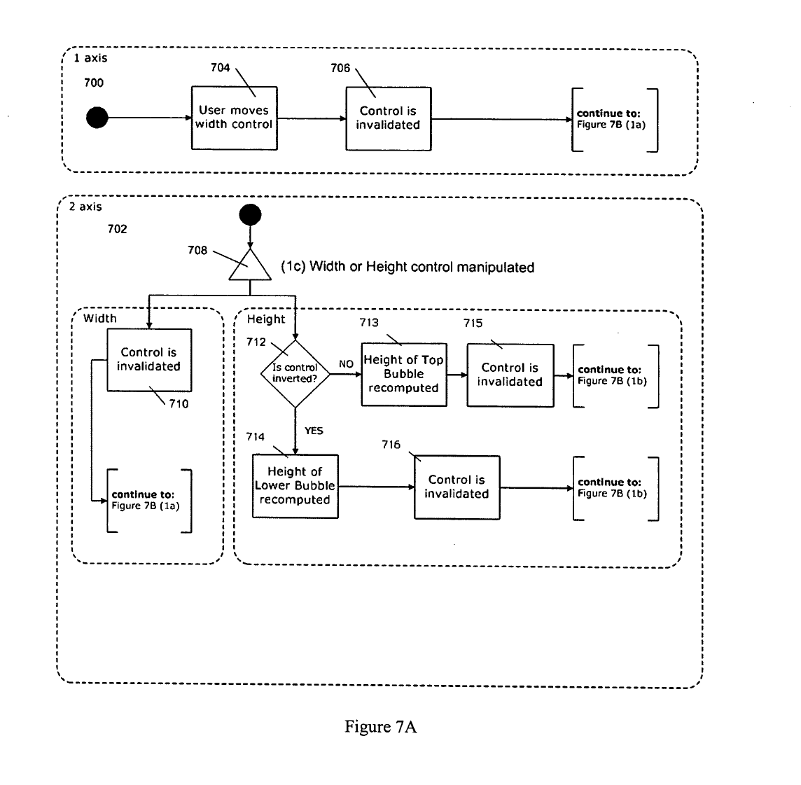

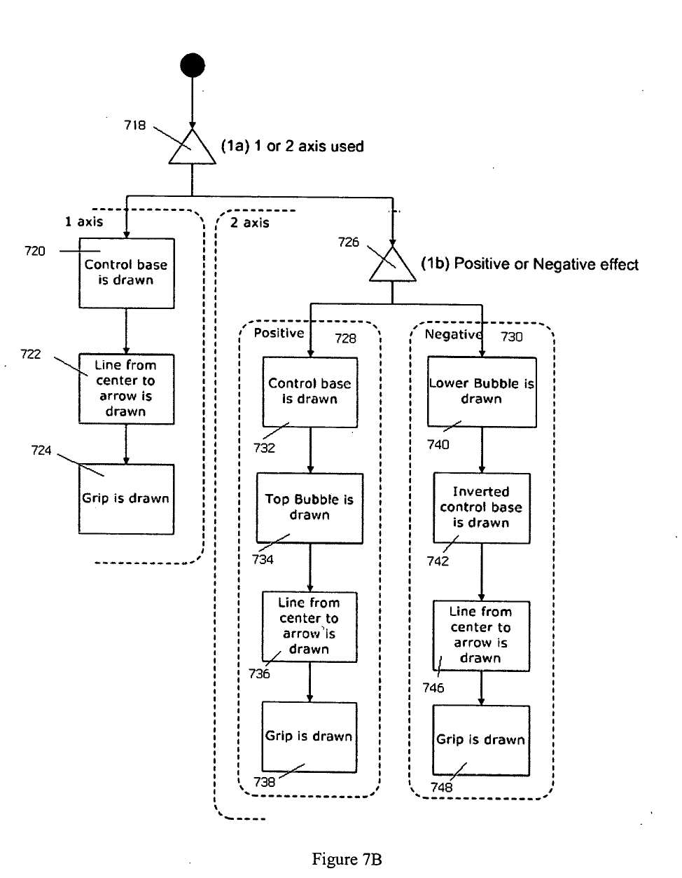

The process flow diagrams in FIG. 7A and FIG. 7B depict how the control object is drawn on the graphical user interface. These two diagrams represent process flows using notation indicating initial state (black filled circles), states and processes (boxes), decision points (diamonds), conditional branches (triangles), flow connectors and continuation references. Conditional areas are given by encapsulating flow objects within dashed-lines. Of the two diagrams presented, the initial state chosen is dependent upon whether this is the first time the control is presented in the application, or whether the control exists and the user simply is manipulating the object.

If the control is appearing in the application for the first time, then FIG. 7B represents the initial point of entry for the process. This process flow diagram notes the presentation of the graphic object for the user to manipulate (and thus, determining which came first: the control or the manipulation with the control). In a given display application (such as a tooth restoration modeling application), the pre-set state of the control in its first appearance is a 1-axis control, although this is not a requirement. In such case, however, the flow of control appearance then follows into a “1 axis” conditional state. In the case of a 2-axis control (one with height and width handles), a “2 axis” conditional state is taken into account, as well as the effect. In a given tooth modeling display application, a first appearance of this control in a 2-axis configuration is “Positive,” although this is not a requirement.

The diagram in FIG. 7A describes two conditional process flows: one for a 1-axis object and another for a 2-axis object, depending upon where the user is within the overall application's navigational architecture. In particular, this diagram shows the control's inherent validation state, and exactly where it would enter in the FIG. 7B process flow diagram.

Thus, the process flow diagrams in FIG. 7A and FIG. 7B depict how the control object is drawn on the graphical user interface. As can be seen, a “1 axis” embodiment means that the control object is drawn as just a circle, in which case the control is limited to the width. The “2 axis” embodiment refers to the preferred embodiment, in which case the control provides both width and height/depth control. As used in the following discussion, a “bubble” refers to the hemisphere, and a “grip” refers to the handle. The control object may or may not be displayed already. As seen in FIG. 7A, in the 1 axis embodiment 700, the routine begins at step 704 when the user moves the width control. As noted above, this function typically occurs when the user selects the handle and moves it, e.g., by stretching. The function causes the current control object to be invalidated, which is step 706. Process control then moves to the process flow diagram in FIG. 7B, which will be described below. As also seen in FIG. 7A, in the 2 axis embodiment, the routine begins at step 708 by testing whether the user has applied a width or height manipulation. If a width manipulation has occurred, the routine branches to the left side of the diagram and performs step 710, which invalidates the current control. Process control then continues in FIG. 7B, as previously described. If, however, a height manipulation has occurred, the routine then tests at step 712 to determine whether the current control is inverted (meaning that the hemisphere is below the equatorial circle). If so, at step 714, the height of the lower bubble is re-computed and then, at step 716, the control is invalidated; control then is transferred to the process flow in FIG. 7B. The invalidating step signals to the program that it is ready to redraw the control. If, however, the current control is not inverted, the routine continues at step 713 to re-compute a height of the bubble (which, at this point, is positive) and then, at step 715, to invalidate the control. After step 715, control continues in FIG. 7B.

Referring now to FIG. 7B, process control depends on which type of control, 1 axis or 2 axis, is currently being displayed. Thus, at step 718, a test is first performed to determine the current control. If the control is a 1 axis, the process continues on the left side of the figure. At step 720, the base of the circle is drawn. The routine then continues at step 722. At this step, a line from the center of the circle to an arrow at the circle's edge is drawn. At step 724, the gripping element is drawn. If, however, the control is a 2 axis control, the process continues at step 726 to test whether a positive or negative effect is being applied. If a positive effect is being applied, the steps 728 are carried out; alternatively, if a negative effect is being applied, the steps 730 are carried out. The steps 728 comprise the following functions. At step 732, the control base is drawn. The process flow then continues at step 734, which draws the top bubble. At step 736, a line from the center of the control base to a display arrow is drawn. At step 738, the gripping handle is drawn. The steps 730 comprise the following functions. At step 740, the lower bubble is drawn. At step 742, an inverted control base is drawn. At step 746, a line from the center of the control base to a display arrow is drawn. At step 748, the gripping handle is drawn. This completes the processing.

One of ordinary skill in the art will appreciate that the computer program product code may include additional routines to capture point-and-click movements, as well as routines to smooth the display redrawing functions as needed. Preferably, there are also routines to display the numerical indices and to adjust the values therein, as described above.

The present invention provides numerous advantages over the prior art. The control uses a single user interface object to implement area-of-effect control in two dimensions, e.g., width and height/depth.

The user interface object is not limited for use with a tooth model design program. The area-of-effect control may be used in any display context where it is desired to use a single object to control a given display tool or widget with respect to two or more given characteristics. Thus, the present invention may be used in any application wherein it is desired to display a given tool's width and area of influence (positive or negative). A representative application is a “paint” program that uses a paintbrush metaphor to draws lines and the like. The object may be used with any CAD/CAM application for this purpose, irrespective of the object being modeled or designed.

Moreover, while one preferred embodiment shows the control object as comprised of a closed curved (a circle) having a superimposed hemisphere as has been described and illustrated, this particular geometry should not be construed as limiting. More generally, the control object may be any convenient geometric figure exhibiting a volume, such as a conic, rectangular or cubic solid. Even more generally, the control object can be any solid that has a closed planar curved or polygon base (e.g., for use as the tool width control) and an associated projection (e.g., for use as the tool influence control). A polygon is any closed planar figure made up of several line segments that are joined together (e.g., a triangle, a trapezoid, a pentagon, a hexagon, an octagon, and so forth). In general, shapes of this form may also be referred to as an “n-gon,” where “n” is a positive integer. Thus, according to such alternate embodiments, the control object is shaped as a cone or conic section, as a cylinder or cylinder section, as a cube, as a pyramid, or in any other topologically-equivalent solid defined by a planar base and associated projection. As described above, the planar base and the associated projection are displayed transparently, relative to each other, so that the projection can be moved into and out of the base (i.e. below and above the plane of the base) as has been described.

Further, it is not required that the base portion of the control object be used to control the display tool's width while the projection be used to control the display tool's influence. These functions may be reversed, or one or both of the geometric representations may control any other characteristics of the display tool.

While certain aspects or features of the present invention have been described in the context of a computer-based method or process, this is not a limitation of the invention. Moreover, such computer-based methods may be implemented in an apparatus or system for performing the described operations, or as an adjunct to other dental restoration equipment, devices or systems. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including optical disks, CD-ROMs, and magnetic-optical disks, read-only memories (ROMs), random access memories (RAMs), magnetic or optical cards, or any type of media suitable for storing electronic instructions, and each coupled to a computer system bus. The described functionality may also be implemented in firmware, in an ASIC, or in any other known or developed processor-controlled device.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic. Further, while given components of the system have been described separately, one of ordinary skill will appreciate that some of the functions may be combined or shared in given systems, machines, devices, processes, instructions, program sequences, code portions, and the like.

Having now described my invention, what I claim is as follows:

1. A computer program product tangibly embodying computer program instructions executable by a processor for carrying out a display tool control method, the method comprising:
displaying a circle with a hemisphere superimposed on the circle's diameter, wherein each of the circle and the hemisphere have a display element associated therewith; and
responsive to manipulation of the display element associated with the circle, altering a given first characteristic of the display tool; and
responsive to manipulation of the display element associated with the hemisphere, altering a given second characteristic of the display tool.

2. The computer program product as described in claim 1 wherein the given first characteristic of the display tool is a tool width.

3. The computer program product as described in claim 2 wherein the given second characteristic of the display tool is a tool influence.

4. The computer program product as described in claim 1 wherein the circle and the hemisphere are displayed transparently, relative to each other.

5. The computer program product as described in claim 1 wherein the circle and the hemisphere are displayed transparently, relative to each other, such that the display element associated with the hemisphere may be manipulated in a first, positive direction, or a second, negative direction.

6. The computer program product as described in claim 1 wherein the display tool control method further includes the steps of displaying numerical units adjacent the circle and modifying the numerical units as the display element associated with the circle is manipulated.

7. The computer program product as described in claim 1 wherein the display tool control method further includes the steps of displaying numerical units adjacent the hemisphere and modifying the numerical units as the display element associated with the hemisphere is manipulated.

8. A computer program product tangibly embodying computer program instructions executable by a processor for carrying out a display tool control method, the method comprising:
displaying a circle with a hemisphere superimposed on the circle's diameter, wherein the circle and the hemisphere are displayed transparently, relative to each other, such that the display element associated with the hemisphere may be manipulated in a first, positive direction, or a second, negative direction; and
modifying at least one of: a width of the circle, or a positive or negative height of the hemisphere relative to the circle.

9. The computer program product as described in claim 8 wherein the display tool control method further includes the steps of displaying numerical units adjacent the circle, and modifying the numerical units as the width of the circle is modified.

10. The computer program product as described in claim 8 wherein the display tool control method further includes the steps of displaying numerical units adjacent the hemisphere and modifying the numerical units as the height of the hemisphere is modified.

11. In an application executable in a computer, the computer having a graphical user interface in which a given tool is displayed, the improvement comprising:
program code executable by a processor to display a planar figure with a projection superimposed on an outer edge of the planar figure, wherein the planar figure and the projection are displayed transparently, relative to each other; and
program code executable by the processor to modify at least one of: a dimension of the planar figure, or a positive or negative height of the projection relative to the planar figure, to thereby carry out a control function associated with the given tool.

12. In the application as described in claim 11 wherein the planar figure is one of: a closed curve or an n-gon.

13. In the application as described in claim 11 wherein the projection has a shape determined by the shape of the planar figure.

14. In an application executable in a computer, the computer having a graphical user interface in which a given tool is displayed, the improvement comprising:
program code executable by a processor to display a planar figure; and
program code executable by the processor to modify a dimension of the planar figure, to thereby carry out a control function associated with the given tool.
